(19) United States
(12) Patent Application Publication
(10) Pub. No.: US 2026/0192720 A1
(43) Pub. Date: Jul. 9, 2026

(54) RETAINER FOR ATTACHING A COVERING MATERIAL TO A STRUCTURE

(71) Applicant: YKK Corporation, Tokyo (JP)

(72) Inventors: Satoshi Nakada, Macon, GA (US); Mariano Cuerda, Novi, MI (US); Tsutomu Yamada, Novi, MI (US); Evan Fegan, Macon, GA (US); Kenji Dono, Macon, GA (US)

(21) Appl. No.: 19/132,564

(22) PCT Filed: Nov. 1, 2023
(86) PCT No.: PCT/US2023/078347

§ 371 Date: May 23, 2025

Related U.S. Application Data
(60) Provisional application No. 63/428,958, filed on Nov. 30, 2022.

(51) Int. Cl. B60N 2/60

(52) U.S. Cl. CPC B60N 2/6027

(57) ABSTRACT

A retainer for attaching a sheet to a structure includes a fixing potion, a first engagement feature, and a second engagement feature. The fixing portion may engage an edge of a sheet, such as but not limited to a covering material. The first engagement feature may engage the structure, and the second engagement feature may engage the structure. In various embodiments, the first engagement feature engages the structure at least in a temporary holding configuration of the retainer relative to the structure, and the second engagement feature engages the structure at least in a full engagement configuration of the retainer relative to the structure.

### REFERENCE TO RELATED APPLICATION

This application claims the benefit of U.S. Provisional Patent Application No. 63/428,958, filed on Nov. 30, 2022, and entitled RETAINER FOR ATTACHING A COVERING MATERIAL TO A STRUCTURE, the content of which is hereby incorporated by reference in its entirety.

### FIELD OF THE INVENTION

This application relates to a sheet fastener for fastening edges of a covering material, such as but not limited to a trim cover, to a structure, such as but not limited to seat cushions or a seat frame for a vehicle seat.

### BACKGROUND

Sheet retainers may be used for fastening an edge of a covering material to a structure and/or another covering material. As an example, seats used for automobiles, ships, trains, and/or at school or office, and/or furniture such as a sofa or be, may include a covering material over a cushion material supported on a frame to form a seat surface, a back surface, a headrest surface, an armrest surface, etc. Existing sheet retainers may be difficult for an installer to assemble on a structure and require a tool such as a hammer for assembly. The requirement of tools with existing retainers thereby results in a lengthy installation time and present a safety risk to the installer (e.g., due to misuse of the tool).

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a retainer for attaching a cover material to a structure includes a fixing portion, a first engagement feature, and a second engagement feature. The fixing portion may engage an edge of a sheet. The first engagement feature and the second engagement feature may engage the structure. In some embodiments, the second engagement feature is between the first engagement feature and the fixing portion. In various embodiments, the first engagement feature and the second engagement feature are configured to sandwich a portion of the structure.

According to various embodiments, a retainer for a structure includes a fixing portion configured to engage an edge of a sheet and a first engagement feature for engaging the structure at least in a temporary holding configuration of the retainer relative to the structure. The retainer also includes a second engagement feature for engaging the structure at least in a full engagement configuration of the retainer relative to the structure.

In some embodiments, a retainer for a structure includes a configuration that is fixed to the structure by sandwiching the structure between a first engagement feature and a second engagement feature of the retainer.

In various embodiments, a retainer for a structure includes a first engagement feature configured for a temporary holding function by being hooked on the structure.

In certain embodiments, a retainer for a structure includes a second engagement feature having a protrusion that abuts an end of the frame in a full engagement configuration.

In some embodiments, a retainer for a structure includes a second engagement feature that is configured to engage the frame in a full engagement configuration and such that a predetermined amount of the retainer is inserted into the structure.

In various embodiments, a retainer for a structure includes a first engagement feature that engages a protrusion of the structure and a second engagement feature that encloses an edge of the structure in a full engagement configuration. Such engagement may suppress and/or eliminate rattling of the retainer relative to the structure when fully assembled.

In some embodiments, a retainer for a structure includes a first engagement feature that engages the structure in both a temporary holding configuration and a full engagement configuration. The retainer also includes a second engagement feature that engages the frame in the full engagement configuration.

In various embodiments, a retainer for a structure includes a first engagement feature that includes a hook or U-shaped engagement feature and a second engagement feature that includes a hook or protrusion engagement feature.

In some embodiments, a retainer for a structure includes a first engagement feature and a second engagement feature, and at least the first engagement feature is elastically deformable.

In certain embodiments, a method of attaching a sheet to a structure using a retainer includes supporting an edge of the sheet on a fixing portion of the retainer. The method includes inserting a first engagement feature of the retainer into a channel defined by the structure and such that the retainer is in a temporary holding configuration. The method may include rotating the retainer relative to the frame and applying a force pushing the retainer further into the channel such that a second engagement feature of the retainer engages the frame in a full engagement configuration.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 illustrates a seat with a covering material attached to a structure and with the structure being a seat back frame according to embodiments of the disclosure.

FIG. 2 illustrates a retainer attaching a covering material to a structure and with the structure being a seat back frame according to embodiments of the disclosure.

FIG. 3 is a view of the retainer, covering material, and seat back frame taken along line 3-3 in FIG. 2.

FIG. 4 is a perspective view of the retainer of FIG. 2.

FIG. 5 is a side view of the retainer of FIG. 2.

FIGS. 6A-C illustrate steps for engaging the retainer with the seat frame of FIG. 2 to attach the covering material to the seat frame according to embodiments.

FIG. 7 illustrates a retainer for attaching a covering material to a structure and with the structure being a seat back frame according to embodiments of the disclosure.

FIG. 8 illustrates a retainer for attaching a covering material to a structure and with the structure being a seat back frame according to embodiments of the disclosure.

FIG. 9 illustrates a retainer for attaching a covering material to a structure and with the structure being a seat back frame according to embodiments of the disclosure.

FIG. 10 illustrates a retainer engaged with a structure and with the structure being a seat back frame according to embodiments of the disclosure.

FIGS. 11A-B illustrate a retainer and a structure and with the structure being a seat back frame according to embodiments of the disclosure.

FIGS. 12A-D illustrate steps for engaging a retainer with a structure to attach a covering material to the structure according to embodiments.

FIGS. 13A-C illustrate steps for engaging a retainer with a structure to attach a covering material to the structure according to embodiments.

FIG. 14 illustrates a retainer and a structure and with the structure being a seat back frame according to embodiments of the disclosure.

FIGS. 15A-B illustrate a retainer and a structure and with the structure being a seat back frame according to embodiments of the disclosure.

FIGS. 16A-B illustrate a retainer and a structure and with the structure being a seat back frame according to embodiments of the disclosure.

### DETAILED DESCRIPTION

Described herein are retainers for attaching a covering material to a frame or structure. While the retainers described below are discussed as attaching a covering material to a seat back frame, they are by no means so limited. Rather, embodiments of the retainers described herein may be used to attaching a covering material to various frames or structures as desired. As such, as used herein, a “frame” may refer to various structures and is not intended to be limiting to the frames illustrated herein. Rather, a frame may be any structure, such as but not limited to various rigid structures, formed plates, molded pans, rigid backings, extruded beams, tubes, formed profiles, combinations thereof, and various other structures to which a covering material may be attached. Moreover, while the figures illustrate a seat back frame, the retainers may attach to other seat parts, such as but not limited seat cushions, and in other examples, the retainers may be used in other non-seat applications for attaching a covering material to a structure.

The retainers described herein generally include a fixing portion for supporting an edge of a covering material, a first engagement feature, and a second engagement feature. In certain embodiments, the retainers described herein may allow for a tool-less installation, meaning that a separate tool such as a hammer or the like (as traditionally has been required) is not needed nor required to assemble the retainer to a seat back frame. Such tool-less installations may have reduced assembly time compared to traditional approaches and may provide improved safety to a worker (e.g., because injury risk from a separate tool is eliminated). The retainers described herein may be assembled by hand and may be ergonomically friendly, which may improve the production efficiency compared to traditional approaches.

In certain embodiments, the retainers described herein optionally may allow for the retainers and covering material to be supported on a seat back frame in an intermediate or temporary holding configuration in which the retainer is partially engaged with the seat back frame. The temporary holding configuration may support the weight of the covering material while allowing for alignment of the retainer along the length of the seat back frame, which may allow for easier assembly of the retainer with the seat back frame. As a non-limiting example, a worker may position the retainer in the temporary holding configuration along a length of the seat back frame to ensure desired positioning and/or alignment before subsequently moving the retainer to a full engagement position.

In certain embodiments, the retainers described herein optionally are movable from the temporary holding configuration to the full engagement configuration by rotating the retainer, which may improve the ability of the retainer to be inserted into the seat back frame. Optionally, rotation of the retainer from the temporary holding configuration to the full engagement configuration may allow for insertion of the retainer into the seat back frame with a smaller insertion force compared to traditional approaches. Additionally, or alternatively, the retainers described herein may include elastically deformable portions, which may allow for insertion of the retainer into the seat back frame with a small insertion force.

The retainers described herein may have improved engagement with the seat back frame in the full engagement configuration, which may provide a more secure connection between the retainer and the seat back frame and/or may provide an improved (e.g., uniform) appearance. As non-limiting examples, the retainers described herein may minimize rattling between the retainer and the seat back frame by sandwiching a portion of the seat back frame and/or by contacting at least two different portions of the seat back frame.

Various other benefits and advantages may be realized with the systems and methods provided herein, and the aforementioned advantages should not be considered limiting.

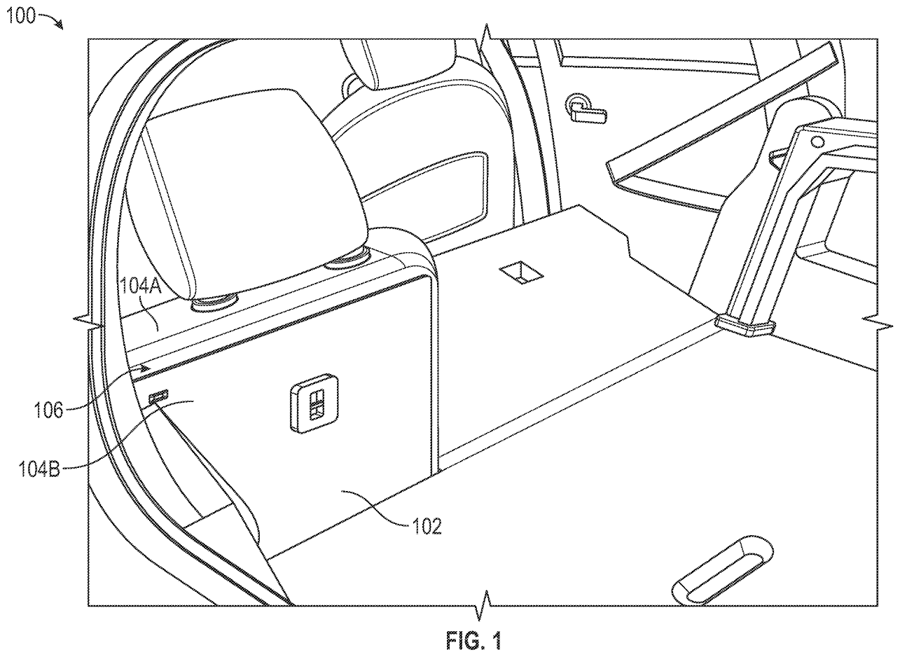

FIG. 1 illustrates an example of a structure with covering materials 104. In the embodiment illustrated, the structure is a seat 100 with a seat back 102. As mentioned, in other embodiments, covering materials 104 may be attached to other structures as desired.

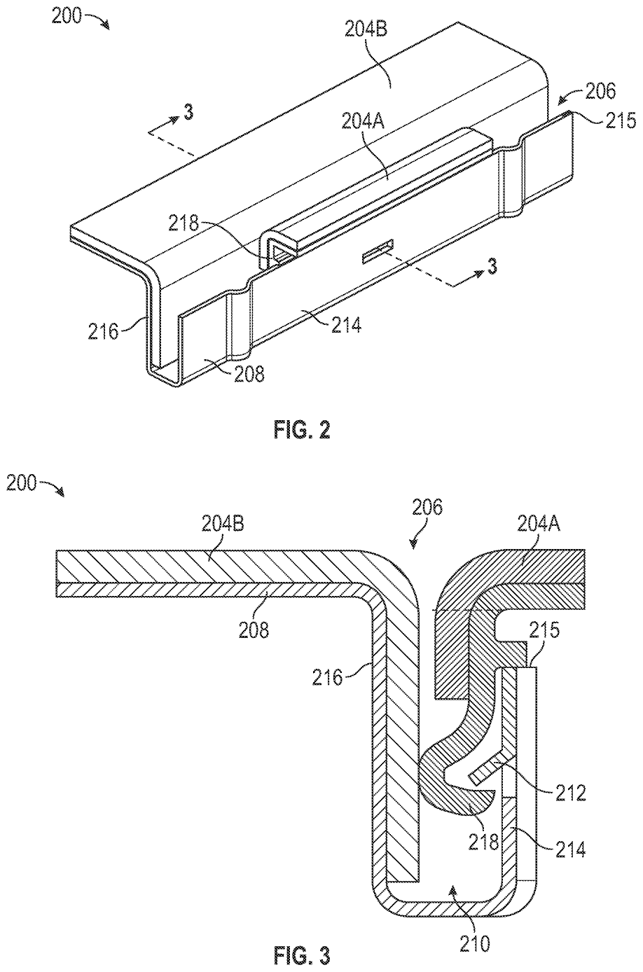

The seat 100 may include one or more covering materials 104, and one or more edges of at least one of the covering materials 104 may be connected to a frame of the seat back 102 (see, e.g., seat back frame 208 illustrated in FIGS. 2 and 3) in a seam region 106 using one or more retainers (discussed in detail below). The covering materials 104 connected to the frame via the one or more retainers may be various types of covering materials and/or combinations of covering material as desired and should not be considered limiting. In the embodiment illustrated, the seat 100 includes two covering materials 104A-B with the covering material 104A being attached to the seat back frame using the one or more retainers. The particular seat 100 illustrated in FIG. 1 should not be considered limiting and covering materials 104 may form a portion of a seat of a moving body such as a vehicle, airplane, train, ship, or the like, forming a portion of furniture, and/or forming a portion of other base material as desired.

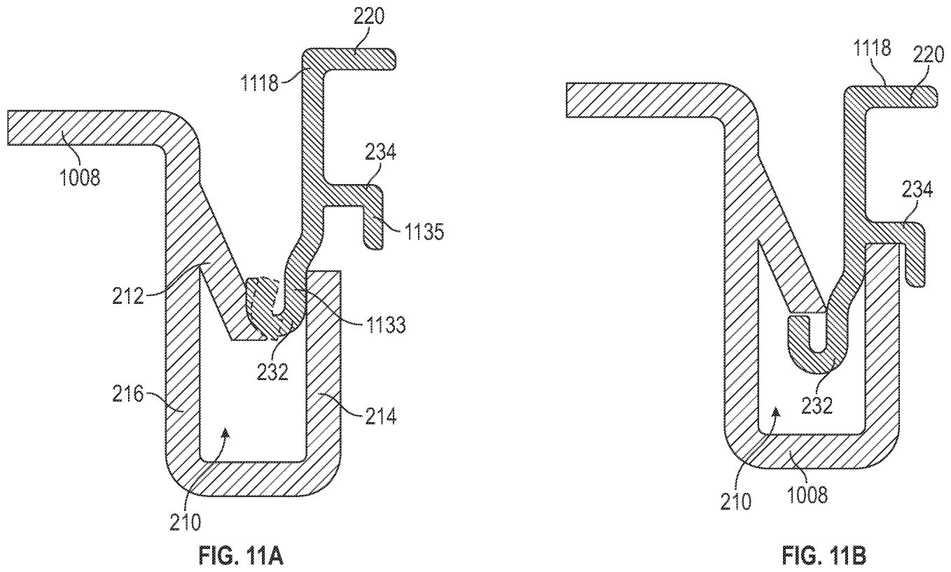

FIGS. 2-6C illustrate a portion of a seam region 206 of a seat 200 according to embodiments. The seat 200 is similar to the seat 100 and includes covering materials 204A-B, of which the covering material 204A is attached to a seat back frame 208 of the seat 200 using one or more retainers 218. In FIGS. 2-6C, the retainer 218 directly engage the seat back frame 208 to connect the covering material 204A to the seat back frame 208. However, in other embodiments, the retainer 218 may engage a holder positioned within the seat back frame 208 (see, e.g., FIGS. 11A-B, 12A-D, and 14).

As illustrated in FIGS. 2 and 3, for example, the seat back frame 208 defines a channel 210. As discussed in detail below, the retainer 218 is insertable into the channel 210 for engaging the seat back frame 208 and connecting the covering material 204 to the seat back frame 208. Optionally, one or more protrusions 212 may extend into the channel 210. When included, the protrusions 212 may extend from a first channel wall 214 and/or a second channel wall 216. In the embodiment of FIGS. 2-6C, at least one protrusion 212 extends from the first channel wall 214.

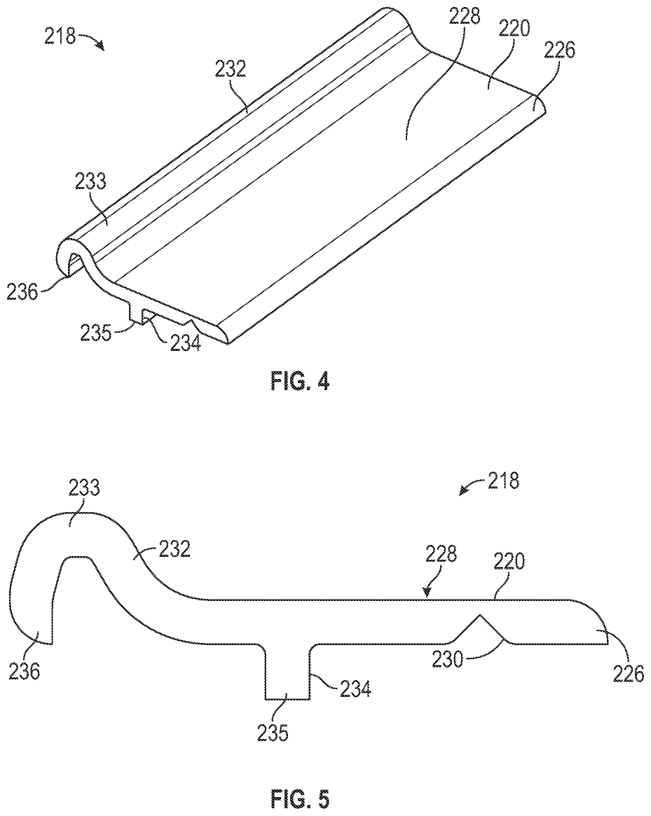

Referring to FIGS. 4 and 5, the retainer 218 generally includes a fixing portion 220, a first engagement feature 232, and a second engagement feature 234. In certain embodiments, the retainer 218 is a monolithic or integrally formed component, although it need not be in other embodiments. The retainer 218 may be constructed from various suitable materials and by various suitable forming techniques as desired. As a non-limiting example, the retainer 218 may be formed by extrusion molding, injection molding, and/or other suitable techniques or combinations of techniques as desired. Optionally, at least a portion of the retainer 218 (e.g., the first engagement feature 232) is an elastically deformable materials such that the portion of the retainer 218 is selectively deformable or compressible during assembly with the seat back frame 208.

The fixing portion 220 optionally includes an end 226 of the retainer 218. As illustrated in FIGS. 4 and 5, for example, the fixing portion 220 includes a surface 228 on which a sheet edge of the covering material 204A may be fixed via various suitable mechanisms or techniques. As a non-limiting example, the covering material 204A may be sewn to the surface 228. The fixing portion 220 may have various shapes or profiles as desired. Optionally, and as illustrated in FIG. 5, the fixing portion 220 may include a shaping feature such as but not limited to a notch 230 such that the shape of the fixing portion 220 may be adjusted as desired. In the embodiment of FIGS. 2-6C, the notch 230 as the shaping feature allows for the fixing portion 220 to be bent from an unbent configuration (see, e.g., FIGS. 4 and 5) to a bent configuration (see, e.g., FIGS. 2, 3, and 6A-C). Optionally, the fixing portion 220 extending in at least two directions (e.g., such as in the bent configuration of FIGS. 2, 3, and 6A-C) may provide an improved appearance for the covering material 204A at the seam region 206.

In various embodiments, the first engagement feature 232 optionally includes an end 236 of the retainer 218 opposite from the end 226. Optionally, the second engagement feature 234 is between the first engagement feature 232 and the fixing portion 220, although it need not be in other embodiments (see, e.g., FIG. 9). Optionally, the second engagement feature 234 is provided along the retainer 218 such that a predetermined amount of the retainer 218 is inserted into the seat back frame 208 in a full engagement configuration (discussed below), which may provide a more uniform appearance to the covering material 204A.

The engagement features 232, 234 may be various suitable features or structures suitable for engaging portions of the seat back frame 208, such as but not limited to the protrusion 212 of the seat back frame 208 and/or an end 215 of the first channel wall 214. In the example illustrated in FIGS. 2-6C, the first engagement feature 232 is a hook feature 233 and the second engagement feature 234 is a protrusion 235. Other non-limiting examples of first engagement features 232 and/or second engagement features 234 include U-shaped features, T-shaped features, hook features with other profiles or shapes, protrusions with other profiles or shapes, etc. In some embodiments, and as illustrated in FIGS. 2-10 and 12A-D, the engagement features 232, 234 may be on and/or extend from a same side of the retainer 218. In other embodiments, and as illustrated in FIGS. 11A-B and 13A-16B, the engagement features 232, 234 may be on and/or extend from opposing sides of the retainer 218.

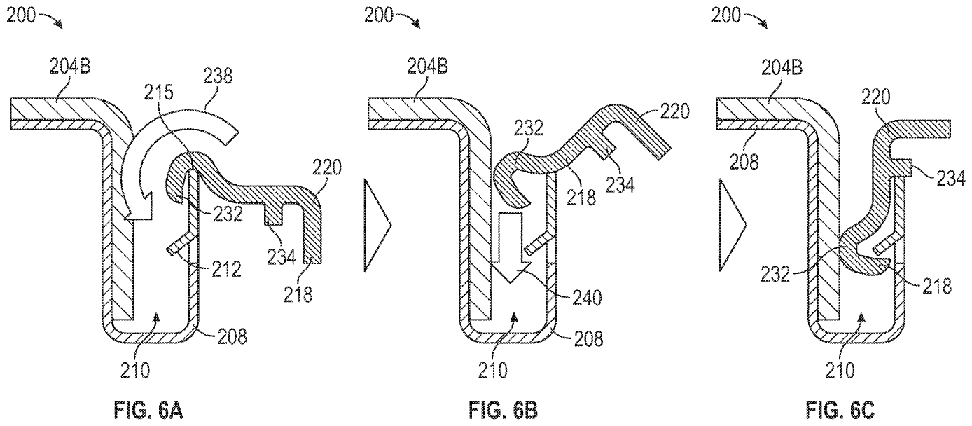

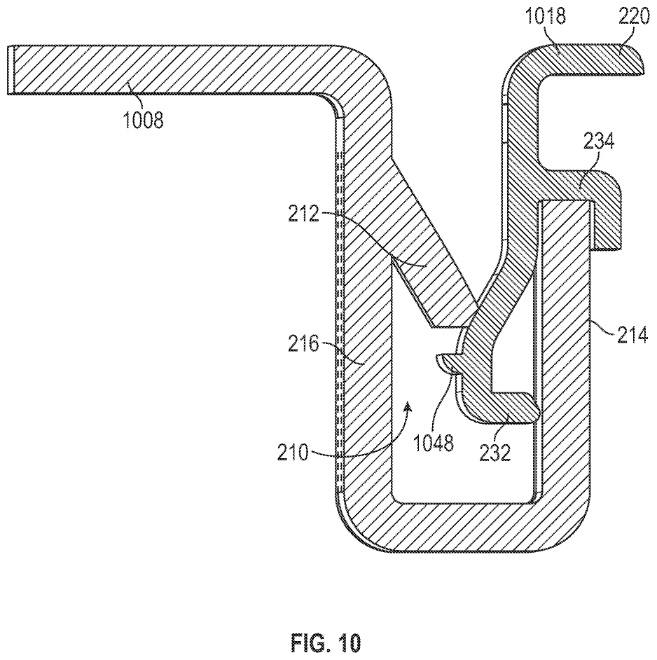

The first engagement feature 232 and the second engagement feature 234 may engage different portions of the seat back frame 208 in the full engagement configuration (see, e.g., FIG. 6C) to attach the retainer 218 to the seat back frame 208. Optionally, and as illustrated in FIG. 6C, in the full engagement configuration, a portion of the seat back frame 208 is sandwiched and/or retained between the first engagement feature 232 and the second engagement feature 234. As a non-limiting example, the protrusion 212 and the end 215 of the first channel wall 214 are sandwiched and/or enclosed by the first and second engagement features 232, 234. Such sandwiching engagement may provide an improved connection between the retainer 218 and the seat back frame 208 and may suppress and/or eliminate rattling of the retainer 218 relative to the seat back frame 208 when fully assembled. In other embodiments, the first and second engagement features 232, 234 need not sandwich the seat back frame 208 to provide attachment of the retainer to the seat back frame (see, e.g., FIGS. 10, 11A-B, 12A-D, and 14).

Referring to FIG. 6A, the first engagement feature 232 optionally allows for the retainer 218 to be in a temporary engagement configuration relative to the seat back frame 208. Optionally, in the temporary engagement configuration, the first engagement feature 232 may engage the portion of the frame that the second engagement feature 234 engages in the fully engaged configuration. As a non-limiting example, in FIG. 6A, the first engagement feature 232 engages the end 215 of the first channel wall 214 in the temporary engagement configuration. In other embodiments, the first engagement feature 232 may engage other portions of the seat back frame 208 in the temporary engagement configuration (see, e.g., FIGS. 11A-B and 12A-D).

In the temporary engagement configuration, the retainer 218 may be engaged with the seat back frame 208 while supporting the weight of the covering material 204A. Such a configuration may allow for improved assembly by allowing a worker to temporarily install the covering material 204A on the seat back frame 208 (e.g., to ensure alignment, etc.) while not having to support the weight of the covering material 204A and/or fully engage the retainer 218 with the seat back frame 208. In various embodiments, the retainer 218 may have an improved ability to be inserted into the seat back frame 208 (e.g., with a reduced required insertion force) by starting from the temporary engagement configuration. As a non-limiting example, and referring to FIGS. 6A-C, the retainer 218 may be rotated (represented by arrow 238) from the temporary engagement position before applying an insertion force (represented by arrow 240) to move the retainer 218 to the full engagement configuration (illustrated in FIG. 6C) such that both the first engagement feature 232 and the second engagement feature 234 engage the seat back frame 208.

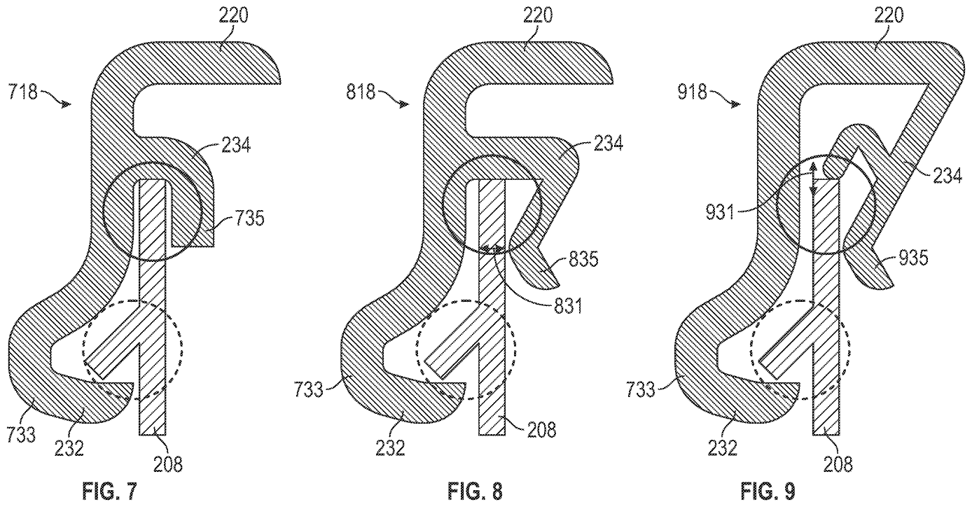

FIG. 7 illustrates another example of a retainer 718 according to embodiments and in a full engagement configuration relative to the seat back frame 208. The retainer 718 is similar to the retainer 218 except that the first engagement feature 232 is a hook portion 733 with a different profile and the second engagement feature 234 is a hook feature 735. The retainer 718 engages the two portions of the frame 208 in the areas encircled by the red and blue circles. Similar to the retainer 218, the retainer 718 sandwiches the frame 208 in the full engagement configuration.

FIG. 8 illustrates another example of a retainer 818 according to embodiments and in a full engagement configuration relative to the seat back frame 208. The retainer 818 is similar to the retainer 718 in that the first engagement feature 232 is the hook portion 733. Compared to the retainer 718, the second engagement feature 234 of the retainer 818 is a hook feature 835 with a different profile. The retainer 818 engages the two portions of the frame 208 in the areas encircled by the red and blue circles. Similar to the retainers 218 and 718, the retainer 818 sandwiches the frame 208 in the full engagement configuration. In certain embodiments, the retainer 818 with the hook feature 835 may allow for the retainer 818 to accommodate various frame thicknesses (represented by arrows 831 in FIG. 8). In other words, the retainer 818 may be used to attach a covering material to a variety of types of frames which may or may not have different thicknesses. In some embodiments, the hook feature 835 optionally may at least partially flex in the horizontal direction to accommodate various frame thicknesses.

FIG. 9 illustrates another example of a retainer 918 according to embodiments and in a full engagement configuration relative to the seat back frame 208. Compared to the retainer 218, the second engagement feature 234 of the retainer 918 extends from the fixing portion 220 and furthermore is a hook feature 935. The first engagement feature 232 of the retainer 918 is the hook portion 733. The retainer 918 engages the two portions of the frame 208 in the areas encircled by the red and blue circles. Similar to the retainers 218, 718, and 818, the retainer 918 sandwiches the frame 208 in the full engagement configuration. Similar to the retainer 818, the retainer 918 may accommodate a plurality of frame thicknesses. In addition, the hook feature 935 may allow the retainer 918 to accommodate various frame heights (i.e., the vertical distance between the portion of the frame 208 circled in red and the portion of the frame 208 circled in blue). Such accommodation is represented by arrows 931 in FIG. 9. In some embodiments, the hook feature 935 optionally may at least partially flex in the vertical direction to accommodate various frame heights.

FIG. 10 illustrates another example of a retainer 1018 according to embodiments. The retainer 1018 is illustrated in a full engagement configuration with a seat back frame 1008. The seat back frame 1008 is similar to the seat back frame 208 except that the protrusion 212 extends from the second channel wall 216. The retainer 1018 is similar to the retainer 218 except that it includes an optional supplemental engagement feature 1048. When included, the supplemental engagement feature 1048 may optionally engage the protrusion 212 extending form the second channel wall 216. In this example, the retainer 1018 may have at least three points of contact between the retainer 1018 and the seat back frame 1008 (e.g., contact between the first engagement feature 232 and the seat back frame 1008, contact between the second engagement feature 234 and the seat back frame 1008, and contact between the protrusion 212 and the retainer 1018), which may provide further improved engagement between the retainer 1018 and the seat back frame 1008.

FIGS. 11A-B illustrate another example of a retainer 1118 according to embodiments. In FIG. 11B, the retainer 1118 is illustrated in a full engagement configuration with the seat back frame 1008. The retainer 1118 is similar to the retainer 218 except that the profile of the fixing portion 220 of the retainer 1118 is different, the first engagement feature 232 of the retainer 1118 includes a hook feature 1133 facing a direction opposite that of the retainer 218, and the second engagement feature 234 is a hook feature 1135. In the example of FIGS. 11A-B, the opposite-facing hook feature 1133 as the first engagement feature 232 may engage the protrusion 212 on the second channel wall 216. As illustrated in FIGS. 11A-B, a portion of the retainer 1118, such as but not limited to the first engagement feature 232, may be elastically deformable such that the portion of the retainer 1118 is selectively movable between a compressed configuration (FIG. 11A) and uncompressed configuration (FIG. 11B). When included, the elastically deformable portion of the retainer 1118 may facilitate engagement between the retainer 1118 and the seat back frame 1008.

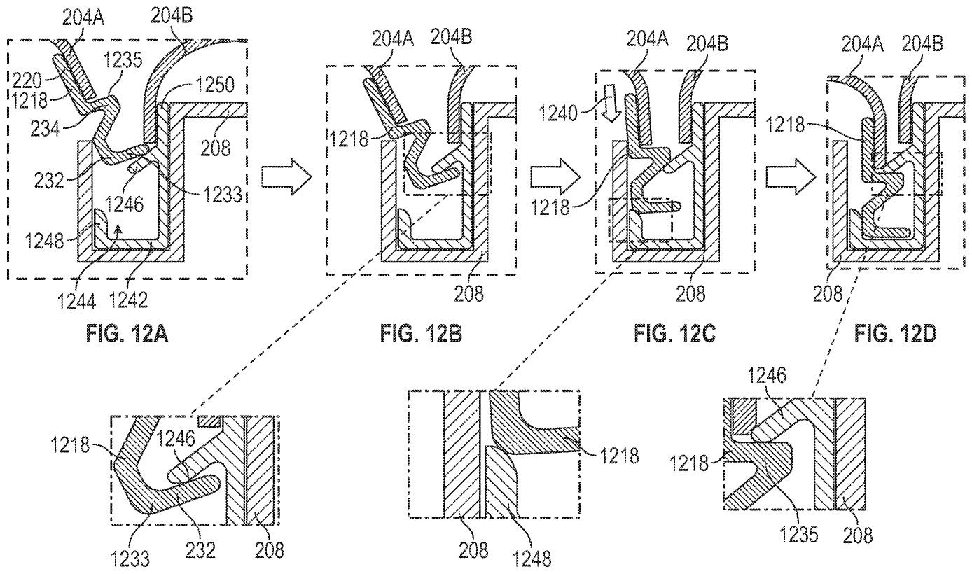

FIGS. 12A-D illustrate another example of a retainer 1218 according to embodiments. Compared to the retainer 218, which directly engages the seat back frame 208, the retainer 1218 engages a holder 1242 positioned within the seat back frame 208. The retainer 1218 is similar to the retainer 218 except that the fixing portion 220 extends in a single direction. In addition, compared to the retainer 218, a hook feature 1233 as the first engagement feature 232 extends from an outermost extent of a protrusion 1235 as the second engagement feature 234.

The holder 1242 generally includes a receiving area 1244 that is at least partially defined by holder extensions 1246, 1248. Optionally, the holder extensions 1246, 1248 may include features such as but not limited to curved surfaces that facilitate movement of the retainer 1218 relative to the holder 1242 during assembly. Optionally, the holder 1242 may include a fixing portion 1250 for attaching a covering material such as the covering material 204B. The particular shape of the holder 1242, the receiving area 1244, the extensions 1246, 1248, and/or the fixing portion 1250 should not be considered limiting on the disclosure. The holder 1242 may be attached or otherwise secured to the seat back frame 208 using various techniques or mechanisms as desired.

A method of assembling the retainer 1218 with the seat back frame 208 may include positioning the retainer 1218 in the temporary holding configuration by partially inserting the retainer 1218 into the receiving area 1244 and such that the first engagement feature 232 engages the holder extension 1246 (FIG. 12B). To move the retainer 1218 from the temporary holding configuration to the full engagement configuration, the method may include optionally rotating the retainer 1218 such that the first engagement feature 232 engages the holder extension 1248 and the second engagement feature 234 engages the holder extension 1246 as illustrated in FIG. 12C. The method may include applying an insertion force (represented by arrow 1240 in FIG. 12C) to the retainer 1218 to move the retainer 1218 to the full engagement configuration as illustrated in FIG. 12D. In certain embodiments, in the full engagement configuration, the engagement features 232, 234 are both at least partially within the receiving area 1244 and/or such that the engagement features 232, 234 engage the holder extension 1246, 1248 within the receiving area 1244.

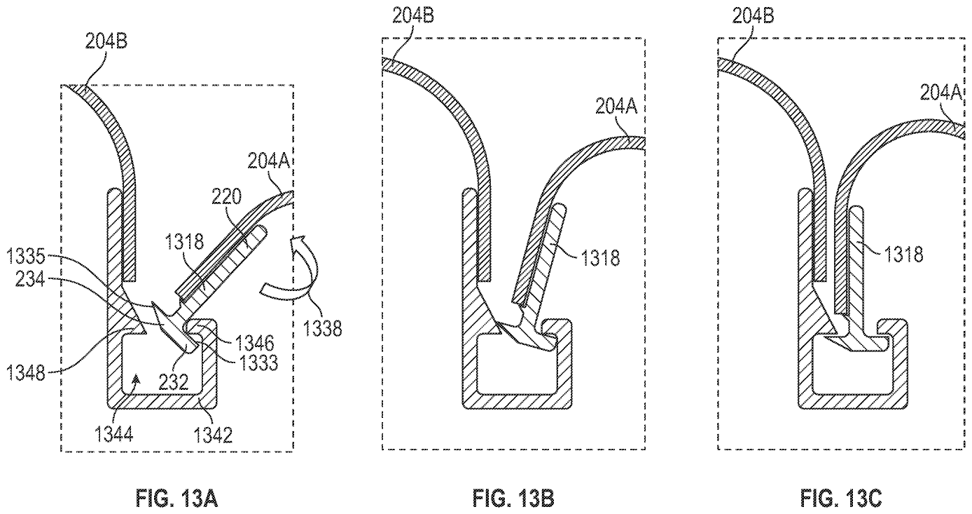

FIGS. 13A-C illustrate another example of a retainer 1318 according to embodiments. Similar to the retainer 1218, the retainer 1318 engages a holder 1342 positioned within a seat back frame. The retainer 1318 is similar to the retainer 218 except that the fixing portion 220 extends in a single direction. In addition, compared to the retainer 218, the first engagement feature 232 is a protrusion 1333 extending in a first direction and the second engagement feature 234 is a second protrusion 1335 extending in a direction opposite from the first direction, and the engagement features 232, 234 together form a T-shaped retainer 1318. As illustrated in FIGS. 13A-C, a profile of the protrusion 1333 may be different from a profile of the protrusion 1335, although they need not be in other embodiments. In certain embodiments, the profile of the protrusion 1335 may facilitate rotation of the retainer 1318 relative to the holder 1342.

The holder 1342 is similar to the holder 1242 except that the holder 1342 includes holder extensions 1346, 1348 and a receiving area 1344 with shapes and/or profiles different from that of the holder 1242.

As illustrated in FIGS. 13A-C, a method of assembling the retainer 1318 with the holder 1342 includes partially inserting the retainer 1318 into the receiving area 1344 and such that the first engagement feature 232 engages the holder extension 1346 (FIG. 13A). To move the retainer 1318 to the full engagement configuration, the method may include rotating the retainer 1318 (represented by arrow 1338) such that the first engagement feature 232 continues to engage the holder extension 1346 and the second engagement feature 234 engages the holder extension 1348 as illustrated in FIG. 13B. In certain embodiments, at least a portion of the protrusion 1335 (e.g., the tip of the protrusion 1335) may be flexible and/or elastically deformable such that the protrusion 1335 bends moderately, which may make it easier to insert the second engagement feature 234 into the receiving area 1344. The method may include further rotating the retainer 1318 and applying an insertion force to the retainer 1318 to move the retainer 1318 to the full engagement configuration as illustrated in FIG. 13C. In certain embodiments, in the full engagement configuration, the engagement features 232, 234 are both at least partially within the receiving area 1344 and/or such that the engagement features 232, 234 engage the holder extension 1346, 1348 within the receiving area 1344.

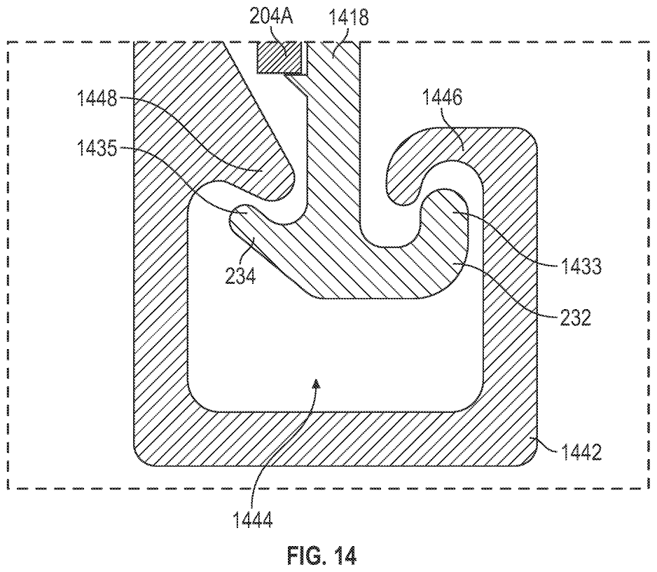

FIG. 14 illustrates another example of a retainer 1418 and holder 1442 according to embodiments. The retainer 1418 is similar to the retainer 1318 except that the first engagement feature 232 is a hook feature 1433 and the second engagement feature 234 is a hook feature 1435. The holder 1442 is similar to the holder 1342 except that the holder 1442 includes hook features as a holder extensions 1446, 1448.

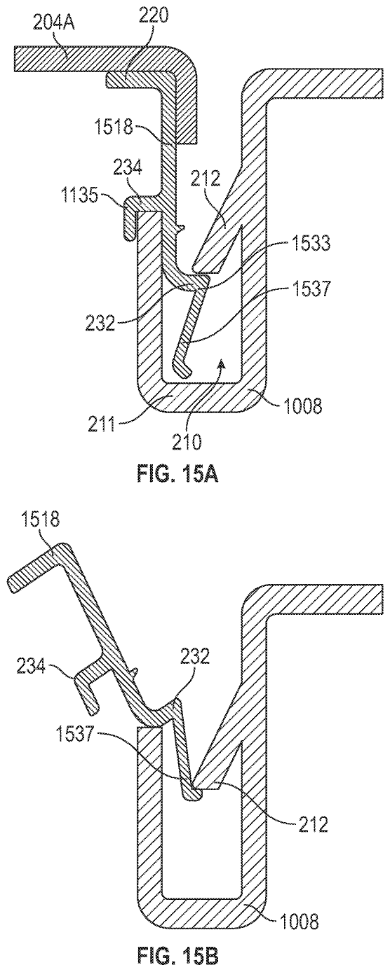

FIGS. 15A-B illustrate another example of a retainer 1518 with the seat back frame 1008 according to embodiments. FIG. 15A illustrates the retainer 1518 in a full engagement configuration, and FIG. 15B illustrates the retainer 1518 in a temporary holding configuration. The retainer 1518 is similar to the retainer 1318 in that the first engagement feature 232 is a protrusion 1533 extending in a first direction. The protrusion 1533 as the first engagement feature 232 has a different profile compared to the protrusion 1333. In some examples, an extension 1537 of the protrusion 1533 may allow the retainer 1518 to accommodate frames having various channel depths (i.e., a distance from a lower portion of the protrusion 212 to a base portion 211 of the channel 210). In certain embodiments, and as illustrated in FIG. 15B, the extension 1537 may facilitate positioning of the retainer 1518 in a temporary holding configuration. Similar to the retainer 1118, the retainer 1518 includes the hook feature 1135 as the second engagement feature 234 and extends in a direction opposite from the first engagement feature 232.

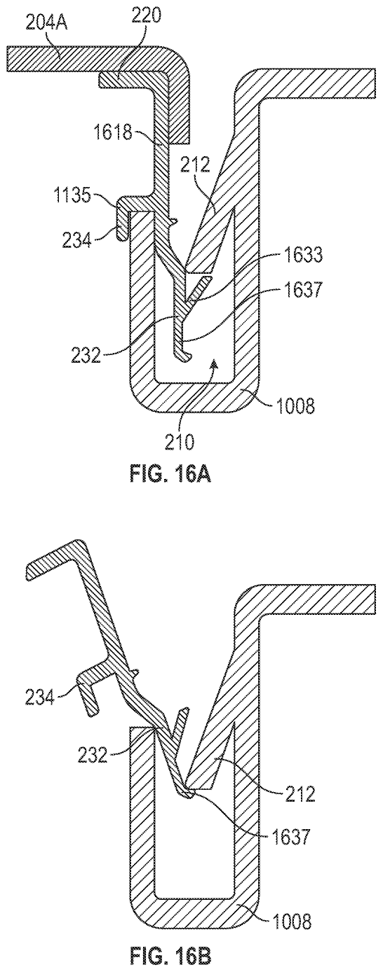

FIGS. 16A-B illustrate another example of a retainer 1618 with the seat back frame 1008 according to embodiments. FIG. 16A illustrates the retainer 1518 in a full engagement configuration, and FIG. 16B illustrates the retainer 1518 in a temporary holding configuration. The retainer 1618 is similar to the retainer 1518 in that the second engagement feature 234 is the hook feature 1135. Compared to the retainer 1518, the retainer 1618 includes a hook feature 1633 as the first engagement feature 232 and that extends in a direction opposite from the second engagement feature 234. Similar to the retainer 1118, the hook feature 1633 of the retainer 1618 may be elastically deformable and movable between a compressed configuration and uncompressed configuration. When included, the elastically deformable hook feature 1633 may facilitate engagement between the retainer 1618 and the seat back frame 1008. Optionally, an extension 1637 of the hook feature 1633 may further facilitate initial engagement of the hook feature 1633 with the frame 1008 and guiding of the retainer 1618 into the channel 210. As illustrated in FIG. 16B, in various embodiments, the extension 1637 may further facilitate positioning of the retainer 1618 in a temporary holding configuration.

A collection of exemplary embodiments is provided below, including at least some explicitly enumerated as an “Illustration” providing additional description of a variety of example embodiments in accordance with the concepts described herein. These illustrations are not meant to be mutually exclusive, exhaustive, or restrictive; and the disclosure not limited to these example illustrations but rather encompasses all possible modifications and variations within the scope of the issued claims and their equivalents.

Illustration 1. A retainer for attaching a sheet to a structure, the retainer comprising: a fixing portion configured to engage an edge of the sheet; a first engagement feature for engaging the structure; and a second engagement feature between the first engagement feature and the fixing portion, the second engagement feature for engaging the structure, wherein the first engagement feature and the second engagement feature are configured to sandwich a portion of the structure.

Illustration 2. The retainer of any preceding or subsequent illustration or combination of illustrations, wherein the first engagement feature is configured for a temporary holding function by being hooked on the structure and is configured to engage the structure in a full engagement configuration and such that a predetermined amount of the retainer is inserted into the structure.

Illustration 3. The retainer of any preceding or subsequent illustration or combination of illustrations, wherein the second engagement feature comprises a protrusion configured to abut an end of the structure in a full engagement configuration.

Illustration 4. The retainer of any preceding or subsequent illustration or combination of illustrations, wherein the first engagement feature comprises a first hook and an extension extending from the first hook, and wherein the second engagement feature comprises a second hook, and wherein the first hook and the second hook face opposite directions.

Illustration 5. The retainer of any preceding or subsequent illustration or combination of illustrations, wherein the first engagement feature includes a first hook, T-shaped feature, or U-shaped engagement feature and the second engagement feature includes a second hook, T-shaped feature, or protrusion engagement feature.

Illustration 6. The retainer of any preceding or subsequent illustration or combination of illustrations, the first engagement feature includes the first hook and the second engagement feature includes the second hook.

Illustration 7. The retainer of any preceding or subsequent illustration or combination of illustrations, wherein a shape or profile of the first hook is different from a shape or profile of the second hook.

Illustration 8. The retainer of any preceding or subsequent illustration or combination of illustrations, wherein at least the first engagement feature is elastically deformable.

Illustration 9. The retainer of any preceding or subsequent illustration or combination of illustrations, wherein the fixing portion comprises a shaping feature such that a shape of the fixing portion is adjustable.

Illustration 10. The retainer of any preceding or subsequent illustration or combination of illustrations, wherein the fixing portion defines a first end of the retainer and the first engagement feature includes a second end of the retainer opposite from the first end.

Illustration 11. The retainer of any preceding or subsequent illustration or combination of illustrations, wherein the second engagement feature extends from the fixing portion.

Illustration 12. The retainer of any preceding or subsequent illustration or combination of illustrations, wherein the retainer further comprises a supplemental engagement feature for engaging the structure, wherein the supplemental engagement feature is between the first engagement feature and the second engagement feature.

Illustration 13. A retainer for attaching a sheet to a structure, the retainer comprising: a fixing portion configured to engage an edge of the sheet; a first engagement feature for engaging the structure at least in a temporary holding configuration of the retainer relative to the structure; and a second engagement feature for engaging the structure at least in a full engagement configuration of the retainer relative to the structure.

Illustration 14. The retainer of any preceding or subsequent illustration or combination of illustrations, wherein the fixing portion comprises a first end of the retainer and the first engagement feature comprises a second end of the retainer opposite from the first end, and wherein the second engagement feature is between the first end and the second end.

Illustration 15. The retainer of any preceding or subsequent illustration or combination of illustrations, wherein the first engagement feature and the second engagement feature are configured to engage the structure on opposing sides of the retainer.

Illustration 16. The retainer of any preceding or subsequent illustration or combination of illustrations, wherein the first engagement feature includes a hook or U-shaped engagement feature and the second engagement feature includes a hook or protrusion engagement feature.

Illustration 17. The retainer of any preceding or subsequent illustration or combination of illustrations, wherein at least the first engagement feature is elastically deformable.

Illustration 18. A seat comprising the retainer of any preceding or subsequent illustration or combination of illustrations, the structure, and the sheet, wherein the first engagement feature is configured to engage a protrusion of the structure and the second engagement feature is configured to enclose an edge of the structure in the full engagement configuration.

Illustration 19. A method of attaching a sheet to a structure using a retainer, the method comprising: supporting an edge of the sheet on a fixing portion of the retainer; inserting a first engagement feature of the retainer into a receiving area defined by the structure and such that the retainer is in a temporary holding configuration; and rotating the retainer relative to the structure and applying a force pushing the retainer further into the receiving area such that a second engagement feature of the retainer engages the structure in a full engagement configuration.

Illustration 20. The method of any preceding or subsequent illustration or combination of illustrations, wherein, in the full engagement configuration, the first engagement feature and the second engagement feature are both at least partially within the receiving area.

The various aspects, embodiments, implementations or features of the described embodiments can be used separately or in any combination. It should be appreciated that the various elements of concepts from the figures may be combined without departing from the spirit or scope of the invention.

The use of the terms “a” and “an” and “the” and similar referents in the context of describing the invention (especially in the context of the following claims) are to be construed to cover both the singular and the plural, unless otherwise indicated herein or clearly contradicted by context. Directional references such as “up,” “down,” “top,” “bottom,” “left,” “right,” “front,” and “back,” among others, are intended to refer to the orientation as illustrated and described in the figure (or figures) to which the components and directions are referencing. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, or gradients thereof, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, the nearness of completion will be so as to have the same overall result as if absolute and total completion were obtained.

Preferred embodiments of this invention are described herein, including the best mode known to the inventors for conducting the invention. The invention is susceptible to various modifications and alternative constructions, and certain shown exemplary embodiments thereof are shown in the drawings and have been described above in detail. Variations of those preferred embodiments, within the spirit of the present invention, may become apparent to those of ordinary skill in the art upon reading the foregoing description. The inventors expect skilled artisans to employ such variations as appropriate, and the inventors intend for the invention to be practiced otherwise than as specifically described herein. Accordingly, it should be understood that there is no intention to limit the invention to the specific form or forms disclosed, but on the contrary, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

That which is claimed:

1. A retainer for attaching a sheet to a structure, the retainer comprising:
a fixing portion configured to engage an edge of the sheet;
a first engagement feature for engaging the structure; and
a second engagement feature between the first engagement feature and the fixing portion, the second engagement feature for engaging the structure,
wherein the first engagement feature and the second engagement feature are configured to sandwich a portion of the structure.

2. The retainer of claim 1, wherein the first engagement feature is configured for a temporary holding function by being hooked on the structure and is configured to engage the structure in a full engagement configuration and such that a predetermined amount of the retainer is inserted into the structure.

3. The retainer of claim 1, wherein the second engagement feature comprises a protrusion configured to abut an end of the structure in a full engagement configuration.

4. The retainer of claim 1, wherein the first engagement feature comprises a first hook and an extension extending from the first hook, and wherein the second engagement feature comprises a second hook, and wherein the first hook and the second hook face opposite directions.

5. The retainer of claim 1, wherein the first engagement feature includes a first hook, T-shaped feature, or U-shaped engagement feature and the second engagement feature includes a second hook, T-shaped feature, or protrusion engagement feature.

6. The retainer of claim 5, the first engagement feature includes the first hook and the second engagement feature includes the second hook.

7. The retainer of claim 6, wherein a shape or profile of the first hook is different from a shape or profile of the second hook.

8. The retainer of claim 1, wherein at least the first engagement feature is elastically deformable.

9. The retainer of claim 1, wherein the fixing portion comprises a shaping feature such that a shape of the fixing portion is adjustable.

10. The retainer of claim 1, wherein the fixing portion defines a first end of the retainer and the first engagement feature includes a second end of the retainer opposite from the first end.

11. The retainer of claim 1, wherein the second engagement feature extends from the fixing portion.

12. The retainer of claim 1, wherein the retainer further comprises a supplemental engagement feature for engaging the structure, wherein the supplemental engagement feature is between the first engagement feature and the second engagement feature.

13. A retainer for attaching a sheet to a structure, the retainer comprising:
a fixing portion configured to engage an edge of the sheet;
a first engagement feature for engaging the structure at least in a temporary holding configuration of the retainer relative to the structure; and
a second engagement feature for engaging the structure at least in a full engagement configuration of the retainer relative to the structure.

14. The retainer of claim 13, wherein the fixing portion comprises a first end of the retainer and the first engagement feature comprises a second end of the retainer opposite from the first end, and wherein the second engagement feature is between the first end and the second end.

15. The retainer of claim 13, wherein the first engagement feature and the second engagement feature are configured to engage the structure on opposing sides of the retainer.

16. The retainer of claim 13, wherein the first engagement feature includes a hook or U-shaped engagement feature and the second engagement feature includes a hook or protrusion engagement feature.

17. The retainer of claim 13, wherein at least the first engagement feature is elastically deformable.

18. A seat comprising the retainer of claim 13, the structure, and the sheet, wherein the first engagement feature is configured to engage a protrusion of the structure and the second engagement feature is configured to enclose an edge of the structure in the full engagement configuration.

19. A method of attaching a sheet to a structure using a retainer, the method comprising:
supporting an edge of the sheet on a fixing portion of the retainer;
inserting a first engagement feature of the retainer into a receiving area defined by the structure and such that the retainer is in a temporary holding configuration; and
rotating the retainer relative to the structure and applying a force pushing the retainer further into the receiving area such that a second engagement feature of the retainer engages the structure in a full engagement configuration.

20. The method of claim 19, wherein, in the full engagement configuration, the first engagement feature and the second engagement feature are both at least partially within the receiving area.
